(19) United States
(12) Patent Application Publication
(10) Pub. No.: US 2024/0343308 A1
(43) Pub. Date: Oct. 17, 2024

(54) ELECTRIFIED VEHICLE

(71) Applicant: TOYOTA JIDOSHA KABUSHIKI KAISHA, Toyota-shi (JP)

(72) Inventors: Takahiro Kamoshita, Toyota-shi (JP); Koki Kosugi, Nisshin-shi (JP)

(73) Assignee: TOYOTA JIDOSHA KABUSHIKI KAISHA, Toyota-shi (JP)

(21) Appl. No.: 18/591,182

(22) Filed: Feb. 29, 2024

(30) Foreign Application Priority Data
Apr. 11, 2023 (JP) 2023-064307

(51) Int. Cl. B62D 21/15; B60L 53/22; B60T 8/17; B60T 11/22

(52) U.S. Cl. CPC B62D 21/152; B60L 53/22; B60T 11/22; B60T 8/17

(57) ABSTRACT

An electrified vehicle comprising a brake master cylinder included in the brake unit and a charger that converts power supplied from an external power supply into charging power and supplies it to the battery are located in the front compartment. Inside the front compartment, the brake master cylinder is located behind the charger in the longitudinal direction of the vehicle. A protective portion having a slide structure with an inclined surface formed on a portion facing the charger is provided between the brake master cylinder and the charger.

### CROSS-REFERENCE TO RELATED APPLICATION

This application claims priority to Japanese Patent Application No. 2023-064307 filed on Apr. 11, 2023, incorporated herein by reference in its entirety.

### BACKGROUND

### 1. Technical Field

The present disclosure relates to an electrified vehicle.

### 2. Description of Related Art

Japanese Unexamined Patent Application Publication No. 2004-268691 (JP 2004-268691 A) discloses a vehicle including collision energy absorbing means for absorbing collision energy on an occupant by forward movement of a steering column in the event of vehicle collision.

### SUMMARY

It is known that an electrified vehicle includes a charger for charging a battery with electric power supplied from an external power supply. This charger may be disposed in a front compartment in front of a dash panel. In this case, the charger and a brake master cylinder may strongly interfere with each other in the event of vehicle collision, and the casing of the charger may be damaged.

The present disclosure has been made in view of the above circumstances, and an object of the present disclosure is to provide an electrified vehicle that can suppress strong interference between a charger and a brake master cylinder in the event of vehicle collision.

The present disclosure provides an electrified vehicle including a brake master cylinder included in a brake unit, and a charger configured to convert electric power supplied from an external power supply into charging power and supply the charging power to a battery. The brake master cylinder and the charger are disposed in a front compartment. In the front compartment, the brake master cylinder is disposed behind the charger in a longitudinal direction of the vehicle.

A protective portion having a slide structure with an inclined surface provided at a part facing the charger is provided between the brake master cylinder and the charger.

In this configuration, the protective portion having the slide structure with the inclined surface provided at the part facing the charger is provided between the brake master cylinder and the charger. When the charger and the brake master cylinder approach each other in the event of vehicle collision, strong interference between the charger and the brake master cylinder can be suppressed by providing the protective portion including the inclined surface therebetween.

The protective portion may be a protective jig disposed between the brake master cylinder and the charger.

With this configuration, the strong interference between the charger and the brake master cylinder in the event of vehicle collision can be suppressed by disposing the protective jig between the brake master cylinder and the charger.

The brake unit may include a brake electronic control unit and a reservoir tank that are integrated with the brake master cylinder.
The brake electronic control unit and the reservoir tank may be disposed in the front compartment together with the brake master cylinder.
The brake electronic control unit may be disposed between the brake master cylinder and the charger.
The protective portion may have the slide structure at a front part of a housing of the brake electronic control unit that faces the charger.

With this configuration, the strong interference between the charger and the brake master cylinder in the event of vehicle collision can be suppressed by providing the protective portion on the housing of the brake electronic control unit integrated with the master cylinder.

In the present disclosure, the protective portion having the slide structure with the inclined surface provided at the part facing the charger is provided between the brake master cylinder and the charger. When the charger and the brake master cylinder approach each other in the event of vehicle collision, the strong interference between the charger and the brake master cylinder can be suppressed by providing the protective portion including the inclined surface therebetween.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing the front structure of an electrified vehicle in an embodiment;

FIG. 2 is a perspective view of the brake unit; and

FIG. 3 is a diagram illustrating how the input from the charger is released to the outside by the protective portion at the time of a vehicle collision.

### DETAILED DESCRIPTION OF EMBODIMENTS

Hereinafter, the electrified vehicle in the embodiment of the present disclosure will be specifically explained. The present disclosure is not limited to the embodiments described below.

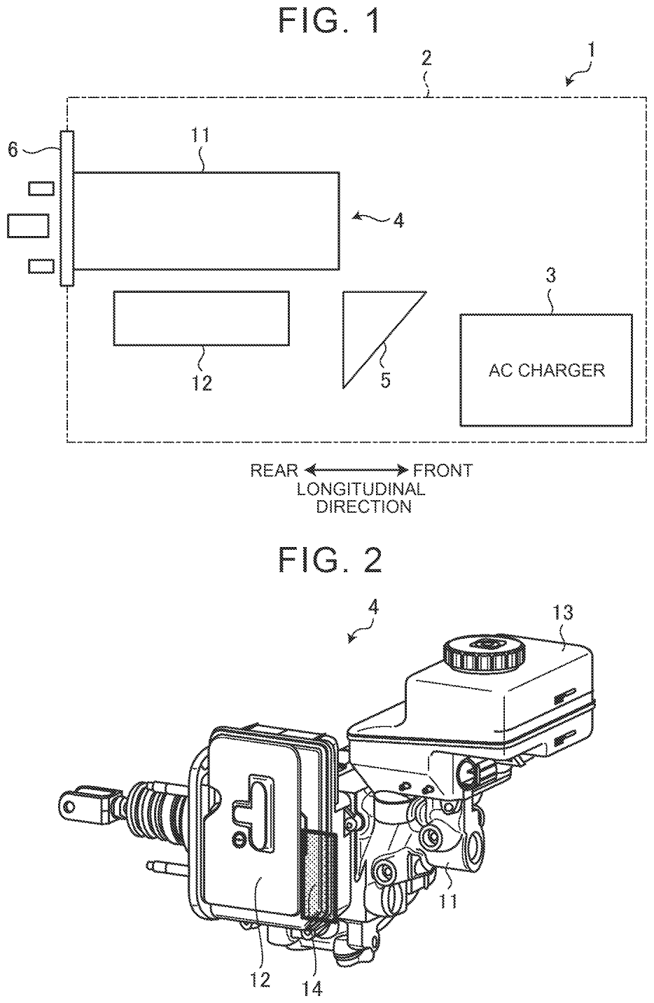

FIG. 1 is a diagram schematically showing the front structure of an electrified vehicle in an embodiment. The electrified vehicle 1 has a front structure in which an AC charger 3, a brake unit 4, and a protective jig 5 are arranged in a front compartment 2.

The front compartment 2 is separated from the vehicle cabin by a dash panel 6. Inside the front compartment 2, a transaxle including a motor and a power transmission mechanism, a power control unit (hereinafter referred to as PCU), and the like are arranged. A motor and a transaxle are housed inside the transaxle case. The PCU converts the DC power of the high voltage battery into AC power and supplies it to the motor in the transaxle case. The PCU is fixed to the top of the transaxle case. An AC charger 3 is fixed above the PCU.

The AC charger 3 is a power conversion device that converts power supplied from an external power supply into charging power and supplies it to the battery. The AC charger 3 is electrically connected to the battery, converts AC power supplied from an external AC power source into DC power, and supplies the DC power to the battery. The housing of the AC charger 3 is fixed to the top of the PCU case.

As shown in FIG. 2, the brake unit 4 includes a brake master cylinder 11, a brake ECU 12, and a reservoir tank 13. The brake unit 4 has a structure in which a brake master cylinder 11, a brake ECU 12, and a reservoir tank 13 are integrated, and the brake ECU 12 and the reservoir tank 13 are arranged together with the brake master cylinder 11 in the front compartment 2 . . . . In the front compartment 2, a brake master cylinder 11 is arranged behind the AC charger 3 in the longitudinal direction of the vehicle.

The brake master cylinder 11 is fixed to a metal dash panel 6 that is a partition wall that partitions the front compartment 2 and the space in the vehicle cabin. The brake master cylinder 11 pressurizes the hydraulic fluid according to the depression force of the brake pedal (brake depression force). The brake master cylinder 11 includes a cylinder housing and a piston that slides within the cylinder housing. The brake master cylinder 11 generates brake fluid pressure according to the stroke of a piston within the cylinder housing. The brake master cylinder 11 is connected to a braking device via brake piping, and supplies brake fluid pressure to the braking device. The brake piping is connected to a port provided in the cylinder housing. The braking device operates according to the brake fluid pressure output from the port of the brake master cylinder 11, and the wheels are braked.

The brake ECU 12 calculates the required deceleration based on the brake pedal force and the brake master cylinder pressure, and controls the braking force so that the electrified vehicle 1 decelerates at the required deceleration. Brake ECU 12 is connected to a brake actuator. The brake actuator includes an electric motor and a plurality of electromagnetic valves. The brake actuator is provided in a hydraulic circuit between the brake master cylinder 11 and a braking device (friction brake device) provided on each wheel. The brake actuator adjusts the hydraulic pressure supplied to the braking device of each wheel, and adjusts the braking force of the electrified vehicle 1.

In addition, the brake ECU 12 is connected to the host ECU via a communication line, and operates the electric motor of the brake actuator based on the required braking force calculated by the host ECU, and opens the solenoid valve of the brake actuator to perform high-pressure operation. The fluid is released and the high pressure hydraulic fluid allows the piston of the brake master cylinder 11 to slide within the cylinder housing. In the brake unit 4, brake fluid pressure generated in the brake master cylinder 11 according to the stroke of the piston is supplied to the braking device from a port provided in the cylinder housing via a brake pipe.

A housing of the brake ECU 12 is fixed to the brake master cylinder 11. The housing of the brake ECU 12 is made of a resin case. For example, the housing of the brake ECU 12 is attached to the cylinder housing of the brake master cylinder 11 by bolting. As shown in FIGS. 1 and 2, the brake ECU 12 is attached to the side of the brake master cylinder 11 in the vehicle width direction. The reservoir tank 13 is attached to the upper part of the brake master cylinder 11. The port of the cylinder housing is provided at the front side in the longitudinal direction of the vehicle, and opens toward the side where the brake ECU 12 is disposed in the vehicle width direction. The brake pipe connected to this port is arranged in front of the front portion 14 of the brake ECU 12 in the longitudinal direction of the vehicle, and extends across the front of the brake ECU 12 in the vehicle width direction.

The protective jig 5 is a jig placed between the brake master cylinder 11 and the AC charger 3. The jig 5 has a slide structure in which an inclined surface is formed in a portion facing the AC charger 3. For example, the jig 5 is made of a metal member. The inclined surface of the jig 5 is a surface that the AC charger 3 comes into contact with (a surface that interferes) when the electrified vehicle 1 has a head-on collision.

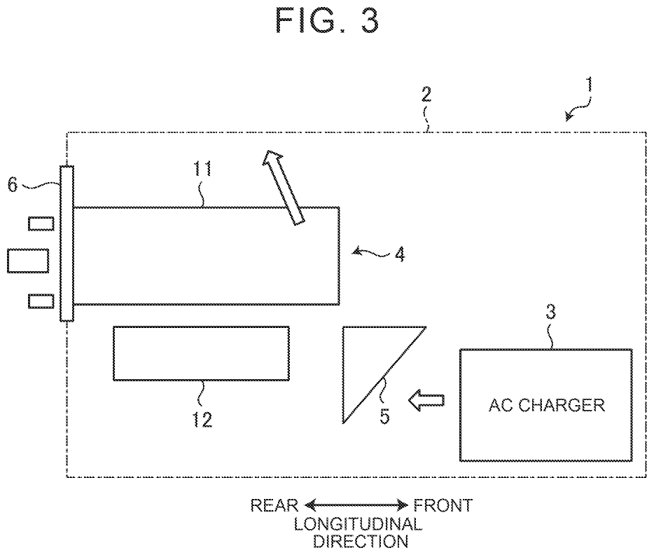

The jig 5 is for preventing strong interference between the brake master cylinder 11 and the AC charger 3, and as shown in FIG. 3, the jig 5 is a protective portion that functions to allow the input of the AC charger 3 to escape to the outside of the brake master cylinder 11 at the time of a vehicle collision. Thereby, when the jig 5 interferes with the AC charger 3, the input (collision load) from the AC charger 3 can be released to the outside of the brake master cylinder 11. Since the jig 5 can prevent strong interference between the AC charger 3 and the brake master cylinder 11 in the event of a head-on collision of the electrified vehicle 1, damage to the housing of the AC charger 3 can be suppressed. Thereby, the high voltage components housed within the housing of the AC charger 3 can be protected in the event of a vehicle collision.

Note that the jig 5 may have any structure as long as it has a sloped surface in the portion facing the AC charger 3, and may be constructed of a shape and material having high rigidity. The material of the jig 5 and the member to which the jig 5 is attached are not particularly limited. For example, the material of the jig 5 is not limited to metal, and may be resin. Furthermore, the jig 5 may be attached to the brake piping. Alternatively, the jig 5 may be fixed to the brake master cylinder 11 by bolting or the like, and placed at a position covering the front portion 14 of the brake ECU 12.

Further, the present disclosure is not limited to the structure in which the jig 5 is disposed, and a structure that functions as a protective portion for the jig 5 may be provided in the casing of the brake ECU 12. In other words, the jig 5 may not be provided. Brake ECU 12 is arranged between brake master cylinder 11 and AC charger 3. Therefore, instead of the jig 5, it is possible to provide a slide structure in which a sloped surface is formed on the front portion 14 of the housing of the brake ECU 12, which faces the AC charger 3.

What is claimed is:

1. An electrified vehicle comprising a brake master cylinder included in a brake unit, and a charger configured to convert electric power supplied from an external power supply into charging power and supply the charging power to a battery, the brake master cylinder and the charger being disposed in a front compartment, wherein
in the front compartment, the brake master cylinder is disposed behind the charger in a longitudinal direction of the vehicle, and
a protective portion having a slide structure with an inclined surface provided at a part facing the charger is provided between the brake master cylinder and the charger.

2. The electrified vehicle according to claim 1, wherein the protective portion is a protective jig disposed between the brake master cylinder and the charger.

3. The electrified vehicle according to claim 1, wherein:
the brake unit includes a brake electronic control unit and a reservoir tank that are integrated with the brake master cylinder;
the brake electronic control unit and the reservoir tank are disposed in the front compartment together with the brake master cylinder;
the brake electronic control unit is disposed between the brake master cylinder and the charger; and
the protective portion has the slide structure at a front part of a housing of the brake electronic control unit that faces the charger.
